(19) United States
(12) Patent Application Publication
(10) Pub. No.: US 2019/0249687 A1
(43) Pub. Date: Aug. 15, 2019

(54) DIFFUSER FOR A CENTRIFUGAL COMPRESSOR AND CENTRIFUGAL COMPRESSOR HAVING THE SAME

(71) Applicant: Carrier Corporation, Jupiter, FL (US)

(72) Inventors: Vishnu M. Sishtla, Manlius, NY (US); Kai Deng, Shanghai (CN); Zhanbo Du, Shanghai (CN); Xili Liu, Shanghai (CN); Scott A. Nieforth, Syracuse, NY (US); Biao Shu, Shanghai (CN); Danni Yuan, Shanghai (CN)

(21) Appl. No.: 16/343,958

(22) PCT Filed: Oct. 23, 2017
(86) PCT No.: PCT/US2017/057849

§ 371 Date: Apr. 22, 2019

(30) Foreign Application Priority Data
Oct. 24, 2016 (CN) 201610924490.3

(51) Int. Cl. F04D 29/46; F04D 27/02

(52) U.S. Cl. CPC F04D 29/462; F05B 2240/123; F04D 27/02

(57) ABSTRACT

A diffuser for a centrifugal compressor and a centrifugal compressor having the same. The diffuser (100) comprises a drive component (110), a transmission assembly (120), an adjustment assembly (130), a spool valve assembly (140) and a rear wall (150); wherein the transmission assembly is used for transmitting power produced by the drive component to the adjustment assembly, the adjustment assembly is capable of circumferentially reciprocating with respect to the rear wall and driving the spool valve assembly to reciprocate axially; and wherein a rolling element (160) is provided between the adjustment assembly and the rear wall. Intervention of a mechanism for adjusting a flow passage width is better achieved by such an arrangement in combination with an existing configuration of the diffuser; and a low-friction fit between the adjustment assembly and the rear wall is achieved by the rolling element.

### FIELD OF THE INVENTION

The present invention relates to the field of refrigeration devices, and more particularly to a diffuser for a centrifugal compressor.

### BACKGROUND

In the field of refrigeration, a compressor is a particularly critical part in a refrigeration system. A good compressor can provide a more excellent refrigeration performance. As one type of refrigeration compressors, centrifugal compressors are widely used in the field of commercial refrigeration due to their capacities of providing efficient and large tonnage of refrigeration. However, under different operating conditions, especially under a condition of partial load operation, problems such as compressor surge and vibration and the like easily occur at a constant diffuser flow passage of a centrifugal compressor. In this context, various structural designs are often adopted to enable an adjustable flow passage width of the compressor diffuser, to thereby improve the surge problem of the centrifugal compressor and to reduce compressor noise and vibration. As one of the embodiments, a spool valve assembly can be provided on the diffuser to achieve the effect of adjusting the flow passage width of the diffuser. However, how to reasonably arrange the spool valve assembly in the diffuser and how to adjust and improve relevant structures have become urgent technical problems to be solved.

### SUMMARY OF THE INVENTION

An object of the present invention is to provide a diffuser for a centrifugal compressor, which is capable of adjusting a flow area of a diffuser flow passage.

A further object of the present invention is to provide a centrifugal compressor which is capable of adjusting a flow area of a diffuser flow passage.

According to one aspect of the present invention, there is provided a diffuser for a centrifugal compressor, comprising: a drive component, a transmission assembly, an adjustment assembly, a spool valve assembly and a rear wall; wherein the transmission assembly is used for transmitting power produced by the drive component to the adjustment assembly, the adjustment assembly is capable of reciprocating circumferentially with respect to the rear wall and driving the spool valve assembly to reciprocate axially; and wherein a rolling element is provided between the adjustment assembly and the rear wall.

According to another aspect of the present invention, there is further provided a centrifugal compressor comprising the diffuser as described above.

### BRIEF DESCRIPTION OF DRAWINGS

FIG. 1 is a stereoscopic view of one embodiment of a diffuser for a centrifugal compressor according to the present invention.

FIG. 2 is a front view of one embodiment of a diffuser for a centrifugal compressor according to the present invention.

FIG. 3 is a schematic view of configurations of a drive component, a transmission assembly and an adjustment ring in one embodiment of a diffuser for a centrifugal compressor according to the present invention.

FIG. 4 is a schematic view of configurations of a ball bearing and a guiding rod in one embodiment of a diffuser for a centrifugal compressor according to the present invention.

FIG. 5 is a schematic view of connection between an adjustment ring and a guiding rod in one embodiment of a diffuser for a centrifugal compressor according to the present invention.

FIG. 6 is a structural schematic view of a spool valve assembly in one embodiment of a diffuser for a centrifugal compressor according to the present invention.

FIG. 7 is a partially enlarged schematic view of a spool valve assembly in one embodiment of a diffuser for a centrifugal compressor according to the present invention.

### DETAILED DESCRIPTION OF EMBODIMENTS

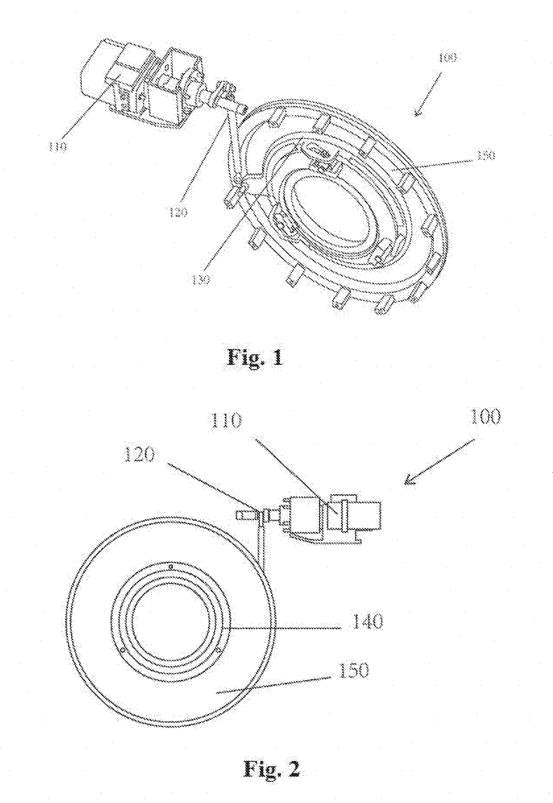

With reference to FIG. 1 and FIG. 2, there is shown an embodiment of a diffuser 100 for a centrifugal compressor. The diffuser 100 comprises a drive component 110, a transmission assembly 120, an adjustment assembly 130, a spool valve assembly 140 and a rear wall 150. The transmission assembly 120 is used for transmitting power produced by the drive component 110 to the adjustment assembly 130, and the adjustment assembly 130 is capable of reciprocating circumferentially with respect to the rear wall 150 and driving the spool valve assembly 140 to reciprocate axially; wherein a ball bearing 160 (shown in FIG. 4) is provided between the adjustment assembly 130 and the rear wall 150. Intervention of a mechanism for adjusting a flow passage width is better achieved by such an arrangement in combination with an existing configuration of the diffuser; and a low-friction fit between the adjustment assembly 130 and the rear wall 150 is achieved by the ball bearing 160, such that the ball bearing 160 can better assume functions of intermediate transmission and diversion of a torque and continuously transmit the torque produced by the drive component 110 to the spool valve assembly 140 with low power consumption, thereby achieving an stepless adjustment for the diffuser flow passage width, efficiently improving shut-down reverse rotation or surge problems of the compressor and reducing exhaust pressure pulsation and vibration noise. According to the teaching of embodiment, other rolling elements that reduce a friction fit similar to the ball bearing 160 are also applicable herein.

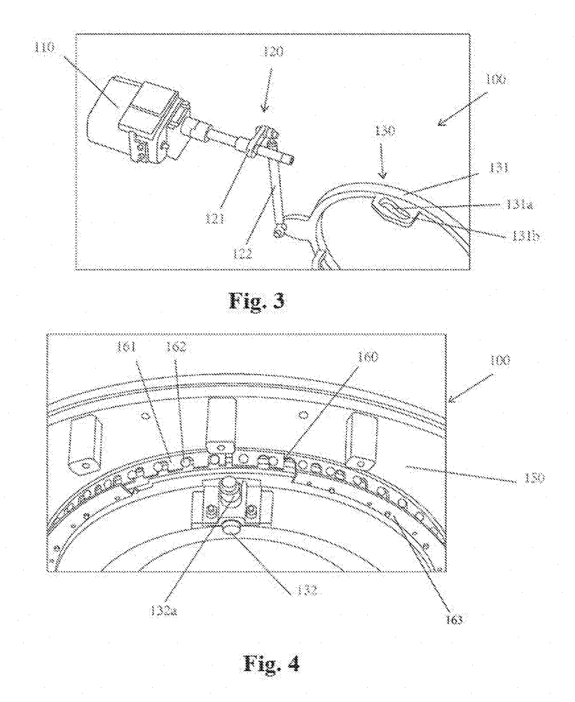

Constituent Details of various assemblies will be illustrated respectively in detail below in conjunction with FIG. 3 to FIG. 7.

With reference to FIG. 3, there is shown a schematic view of configurations of the drive component 110, the transmission assembly 120 and a part of the adjustment assembly 130 in one embodiment of the diffuser for the centrifugal compressor according to the present invention. The drive component 110 is a motor for outputting a torque. The transmission assembly 120 comprises a crank 121 and a connecting rod 122. One end of the crank 121 is connected to an output shaft of the drive component 110 and the other end of the crank 121 is connected to the connecting rod 122. One end of the connecting rod 122 is connected with the crank 121 and the other end of the connecting rod 122 is connected to the adjustment assembly 130. During operation, the drive assembly 120 outputs the torque and drives the crank 121 connected therewith to rotate. Rotary motion of the crank 121 is converted into linear reciprocating motion via the connecting rod 122, and the linear reciprocating motion of the crank 121 is further converted into circumferential reciprocating motion of the adjustment assembly 130 with respect to the rear wall. In this figure, a part of the adjustment assembly 130, i.e., an adjustment ring 131, is shown. An axially protruding boss 131b is provided on the adjustment ring 131 and a diagonal groove 131a for providing a motion diverting function is provided on the boss 131b, so as to continuously transmit the motion. In such an arrangement, under the driving of the drive component 110, the adjustment ring 131 is subjected to circumferential reciprocating rotary motion with respect to the rear wall through the driving of the transmission assembly 120, and further transmits the motion to the spool valve assembly not shown in the figure.

With reference to FIG. 4, there is shown a schematic view of configurations of the ball bearing 160 and a part of the adjustment assembly 130 in one embodiment of the diffuser for the centrifugal compressor according to the present invention. The ball bearing 160 comprises: a ball cage 161 with openings provided circumferentially; balls 162 arranged in the openings; and a baffle 163 for limiting axial movement of the ball cage; wherein the baffle 163 is fixed on the rear wall 150 and the ball cage 161 is arranged circumferentially between an inner side of the adjustment assembly 130 and an outer side of the rear wall 150, such that the rotary reciprocating motion of the adjustment assembly 130 with respect to the rear wall 150 can be effectively improved, so as to reduce the friction loss in the process of motion transmission. Moreover, in this figure, only another part of the adjustment assembly 130, i.e., a guiding rod 132, is shown. A positioning pin 132a protruding circumferentially and outwardly is provided on the guiding rod 132 so as to insert into the diagonal groove 131a of the adjustment ring 131, thereby realizing cooperation between the guiding rod 132 and the adjustment ring 131. Such a cooperation mode and a motion relationship will be explained in detail below.

FIG. 5 is a schematic view of connection between the adjustment ring and the guiding rod in one embodiment of the diffuser for the centrifugal compressor according to the present invention. The adjustment assembly 130 has the adjustment ring 131 and the guiding rod 132 which can be interlocked. It can be appreciated from the figure that upon movement of the drive component, the drive component transmits the torque to the adjustment ring 131 via the transmission assembly, such that the adjustment ring 131 can reciprocate circumferentially with respect to the rear wall 150. During the rotation of the adjustment ring 131, the guiding rod 132 may axially reciprocate with the movement of the adjustment ring under the cooperation between the positioning pin 132a and the diagonal groove 131a, thereby realizing the adjustment of the width of the diffuser flow passage by driving the spool valve assembly to reciprocate axially.

Specifically, an axially protruding boss 131b is provided on the adjustment ring and the diagonal groove 131a is provided on the boss 131b. Such a configuration is more convenient to arrange the diagonal groove 131a, and thus facilitating the cooperation between the adjustment assembly 130 and the spool valve assembly 140. Additionally, such an arrangement does not need to provide a notch on a body of the adjustment ring, thereby better retaining characteristics such as structural strength and the like of the adjustment ring.

More specifically, each diagonal groove 131a comprises straight transition sections located at two ends and a sloped guiding section located in the middle. The straight transition sections at two ends are used for realizing a transition stage of the adjustment so as to provide a certain degree of buffering for the motion of the guiding rod, while the sloped guiding section in the middle is practically used for adjusting the diffuser flow passage.

Alternatively, three diagonal grooves 131a may be arranged circumferentially and uniformly on the adjustment ring 131, into which three guiding rods 132 are inserted, such that the entire spool valve assembly is driven to reciprocate more uniformly.

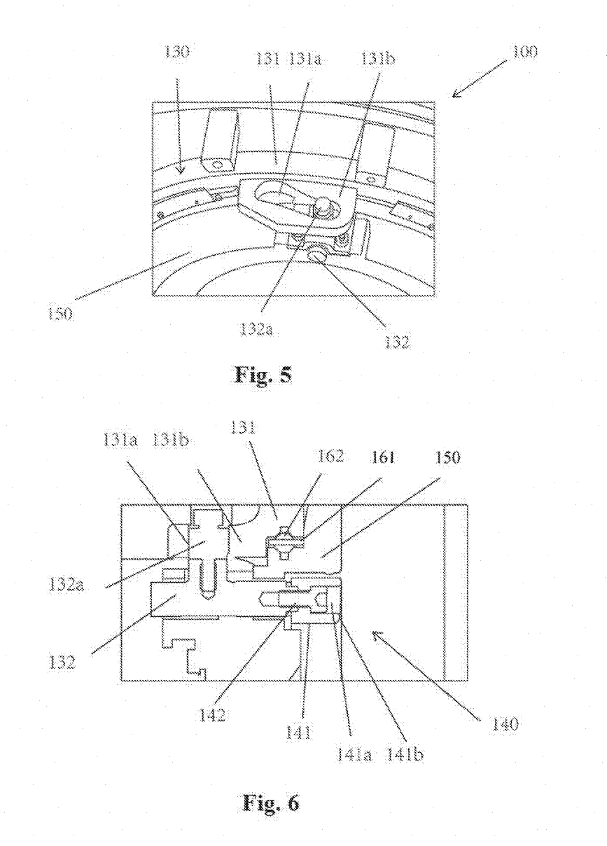

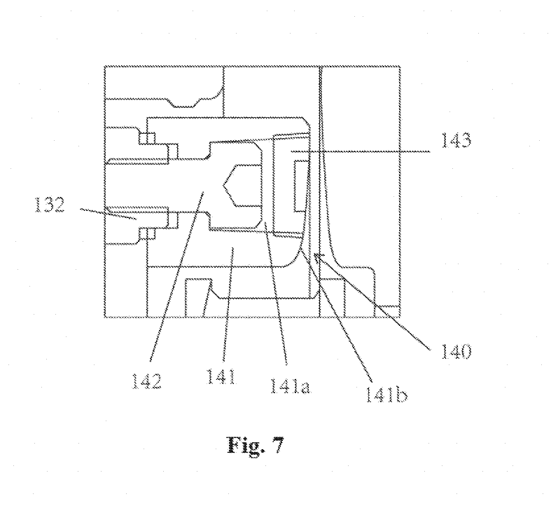

With reference to FIG. 6 and FIG. 7, there are shown a structural schematic view of the spool valve assembly in one embodiment of the diffuser for the centrifugal compressor according to the present invention.

The spool valve assembly 140 comprises a diffuser ring 141 connected to the guiding rod 132 of the adjustment assembly 130; and the diffuser ring 141 is driven by the guiding rode 132 to pass through the rear wall 150 to reciprocate axially, so as to control a flow area of the flow passage of the diffuser 100.

Specifically, the diffuser ring 141 is provided thereon with a bolt hole 141a which is connected with the guiding rod 132 through a bolt 142. Moreover, a bolt hole plug 143 for filling the bolt hole 141a is provided at the bolt hole 141a on the diffuser ring 141.

Alternatively, an end surface 141b, facing the flow passage of the diffuser 100, of the diffuser ring 141 has arc-shaped lines. As one example, with the limitation of the diffuser ring 141, the flow passage of the diffuser is formed as a flow passage tapering from upstream to downstream. As such, a refrigerant air stream flowing at a high speed may undergo a relatively smooth transition at the flow passage, thereby avoiding strong air stream impingement and effectively reducing working noises.

As another embodiment of the present invention, there is further provided a centrifugal compressor which may comprise any one of the embodiments of the diffuser 100 as described above or an improvement or a combination thereof. Therefore, the centrifugal compressor also has corresponding technical effects, and repeated descriptions thereof are thus omitted herein.

Alternatively, in one embodiment of the centrifugal compressor, the diffuser ring 141 is disposed close to a location downstream of an outlet of an impeller of the centrifugal compressor. As such, the adjustment for the flow area of the refrigerant air stream can be realized at the most initial location of the flow passage of the diffuser, and better effects are provided.

Working principles of one embodiment of the centrifugal compressor will be described below in conjunction with the foregoing drawings. Under the condition of partial load operation, a flow rate of the refrigerant is relatively low, at this time, the compressor may easily enter an unstable state, which is referred to as surge. At this time, if a width of a diffuser inlet is reduced, the flow area of the diffuser is reduced, such that the backflow is effectively inhibited, thereby improving the problem of compressor surge and reducing exhaust pressure pulsation and vibration noise. Specifically, the drive component 110 operates at this time, the crank 121 starts to rotate under the driving of the drive component 110 and thereby drives the connecting rod 122 to move upwards, and the upward motion of the connecting rod 122 further drives the adjustment ring 131 to rotate circumferentially and clockwise with respect to the rear wall 150. At this time, with the cooperation of the diagonal groove 131a on the adjustment ring 131 and the positioning pin 132a on the guide ring 132, the guiding rod is driven to pass through the rear wall 150 and advance axially (along an inward direction of the sheet as shown in FIG. 5), so as to drive the diffuser ring 141 connected therewith to pass through the rear wall 150 and advance axially, thereby a flow area of the diffuser flow passage downstream of the outlet of the impeller is reduced. Moreover, the above-described process may be continuously performed, and thereby stepless adjustment for the flow area of the diffuser flow passage may be realized.

Thereafter, if the machine stops operating or restores to a full load operating state, the flow rate of the refrigerant is normal, and the diffuser flow passage may be fully opened. At this time, the drive component 110 is further started, the crank 121 continues to rotate under the driving of the drive component 110 and drives the connecting rod 122 to move downwards. The downward motion of the connecting rod 122 further drives the adjustment ring 131 to rotate circumferentially and counterclockwise with respect to the rear wall 150. At this time, with the cooperation of the diagonal groove 131a on the adjustment ring 131 and the positioning pin 132a on the guide ring 132, the guiding rod is driven to pass through the rear wall 150 and retreat axially (along an outward direction of the sheet as shown in FIG. 5), so as to drive the diffuser ring 141 connected therewith to pass through the rear wall 150 and retreat axially, thereby the flow area of the diffuser flow passage downstream of the outlet of the impeller is increased, and finally the flow area is restored to its initial value.

The above examples mainly illustrate a diffuser for a centrifugal compressor and a centrifugal compressor having the same according to the present invention. Although only part of the embodiments of the present invention are described, those skilled in the art should be understood that the present invention may be implemented in many other forms without departing from the spirit and scope of the present invention. Therefore, the presented examples and embodiments are considered illustrative rather than limiting. Various modifications and replacements may be included in the present invention without departing from the spirit and scope of the present invention as defined in the appended claims.

What is claimed is:

1. A diffuser for a centrifugal compressor, characterized in that, the diffuser comprises a drive component, a transmission assembly, an adjustment assembly, a spool valve assembly and a rear wall; wherein the transmission assembly is used for transmitting power produced by the drive component to the adjustment assembly, the adjustment assembly is capable of reciprocating circumferentially with respect to the rear wall and driving the spool valve assembly to reciprocate axially; and wherein a rolling element is provided between the adjustment assembly and the rear wall.

2. The diffuser according to claim 1, characterized in that, the rolling element is a ball bearing which comprises: a ball cage with openings provided circumferentially; balls arranged in the opening; and a baffle for limiting axial movement of the ball cage; wherein the ball cage is arranged circumferentially between an inner side of the adjustment assembly and an outer side of the rear wall.

3. The diffuser according to claim 1, characterized in that, the transmission assembly comprises a crank and a connecting rod; wherein one end of the crank is connected to an output shaft of the drive component and the other end of the crank is connected to the connecting rod, the crank converts rotary motion of the output shaft of the transmission assembly into linear reciprocating motion of the connecting rod; and the connecting rod drives the adjustment assembly to reciprocate circumferentially with respect to the rear wall.

4. The diffuser according to claim 1, characterized in that, the adjustment assembly comprises an interlocking adjustment ring which reciprocates circumferentially with respect to the rear wall under the driving of the transmission assembly, and a guiding rod which drives the spool valve assembly to pass through the rear wall to reciprocate axially upon movement of the adjustment ring.

5. The diffuser according to claim 4, characterized in that, a diagonal groove is provided circumferentially on the adjustment ring, and a positioning pin inserted into the groove is provided on the guiding rod.

6. The diffuser according to claim 5, characterized in that, an axially protruding boss is provided on the adjustment ring and the diagonal groove is provided on the boss.

7. The diffuser according to claim 5, characterized in that, each diagonal groove comprises straight transition sections located at two ends and a sloped guiding section located in the middle.

8. The diffuser according to claim 1, characterized in that, an axially protruding boss and a diagonal groove disposed on the boss are provided on the adjustment assembly; and the spool valve assembly is inserted into the diagonal groove and is capable of reciprocating axially upon movement of the diagonal groove.

9. The diffuser according to claim 1, characterized in that, the spool valve assembly comprises a diffuser ring connected to the adjustment assembly; and the diffuser ring passes through the rear wall to reciprocate axially under the driving of the adjustment assembly, for controlling a flow area of a diffuser flow passage.

10. The diffuser according to claim 9, characterized in that, the diffuser ring and the adjustment assembly are connected through a bolt, and a bolt hole plug for filling a bolt hole is provided at the bolt hole on the diffuser ring.

11. The diffuser according to claim 9, characterized in that, an end surface, facing the diffuser flow passage, of the diffuser ring has arc-shaped lines.

12. The diffuser according to claim 11, characterized in that, the diffuser flow passage is configured, by the diffuser ring, as a flow passage tapering from upstream to downstream.

13. A centrifugal compressor, characterized in that, the centrifugal compressor comprises the diffuser according to claim 1.

14. The centrifugal compressor according to claim 13, characterized in that, the diffuser ring is arranged close to a location downstream of an outlet of an impeller of the centrifugal compressor.
